(19) United States
(12) Patent Application Publication
(10) Pub. No.: US 2005/0134577 A1
(43) Pub. Date: Jun. 23, 2005

(54) Touch control module for electronic devices

(75) Inventors: Jao-Ching Lin, Hsin-Chuang City (TW); Shyh-In Hwang, Hsin-Chuang City (TW); Lin Chu, Hsin-Chuang City (TW); Chung-Yi Shen, Hsin-Chuang City (TW)

Correspondence Address: BRINKS HOFER GILSON & LIONE;Suite 3600, NBC Tower, 455 N. Cityfront Plaza Drive, Chicago, IL, 60611-5599, US

(73) Assignee: Sentelic Corporation

(21) Appl. No.: 10/797,409

(22) Filed: Mar. 10, 2004

(30) Foreign Application Priority Data
Dec. 19, 2003 (CN) 200310121521.4

(51) Int. Cl. G09G 5/00

(52) U.S. Cl. 345/173

(57) ABSTRACT

A touch control module includes a touch control unit operable so as to generate a contact signal in response to contact with an object, a computing unit coupled electrically to the touch control unit so as to receive the contact signal therefrom, and a transmission interface including a set of transmission lines coupled electrically to the computing unit. The computing unit is configured to generate different control signals, each of which is generated in accordance with a contact position of the object with the touch control unit. Each of the transmission lines is used to transmit a respective one of the control signals to a host unit for scrolling control of a graphical user interface display of the host unit.

### CROSS-REFERENCE TO RELATED APPLICATION

This application claims priority of Chinese Appln. No. 200310121521.4, filed on Dec. 19, 2003.

### BACKGROUND OF THE INVENTION

1. Field of the Invention

The invention relates to a touch control module for electronic devices, more particularly to a touch control module that can simplify decoding of control signals generated thereby.

2. Description of the Related Art

FIG. 1 illustrates a conventional graphical user interface (GUI) display 9 of a computer. The GUI display 9 has a data display portion 91, and vertical and horizontal scroll bars 92, 93 respectively disposed on vertical and horizontal edges of the data display portion 91 for scrolling control of an image shown on the latter. A pointing device (not shown) , such as a mouse or a track ball, is operated for moving a cursor 8 over a selected one of the scroll bars 92, 93 when it is desired to scroll the image shown on the data display portion 91 in the vertical or horizontal direction. However, because the sizes of the scroll bars 92, 93 are relatively small so as to maximize the size of the display area of the data display portion 91, it is difficult and inconvenient for the user to perform image scrolling control through exact positioning of the cursor 8 on the selected scroll bar 92, 93.

In order to overcome the above drawback, U.S. Pat. No. 5,943,052 discloses an apparatus for touchpad-based scroll control that includes a data packet processor working in conjunction with a touchpad. The touchpad is defined with a scroll zone. When the touchpad is operated along the length of the scroll zone, corresponding data packets are generated and are processed by the data packet processor for subsequent control of scrolling of the contents of a data display portion of a GUI display of an electronic device.

In the aforesaid U.S. patent, the data packet processor receives data packets through a transmission line. Hence, the data packet processor requires a relatively complicated decoding scheme for deciphering the operation intended by the user. The complexity of the decoding scheme is further increased when tap-and-drag, single-tap, and double-tap operations are to be considered as well.

### SUMMARY OF THE INVENTION

Therefore, the object of the present invention is to provide a touch control module for electronic devices that can simplify decoding of control signals generated thereby.

Another object of the present invention is to provide an electronic device that includes the touch control module of this invention.

According to one aspect of the invention, a touch control module comprises:

a touch control unit operable so as to generate a contact signal in response to contact with an object;

a computing unit coupled electrically to the touch control unit so as to receive the contact signal therefrom, the computing unit being configured to generate different control signals, each of which is generated in accordance with a contact position of the object with the touch control unit; and

a transmission interface including a set of transmission lines coupled electrically to the computing unit, each of the transmission lines being used to transmit a respective one of the control signals.

The transmission interface is adapted to provide the control signals to a host unit for scrolling control of a graphical user interface display of the host unit.

According to another aspect of the invention, an electronic device comprises:

a host unit including an operating system and a graphical user interface (GUI) display having a scroll bar feature and operably associated with the operating system;

a touch control unit operable so as to generate a contact signal in response to contact with an object;

a computing unit coupled electrically to the touch control unit so as to receive the contact signal therefrom, the computing unit being configured to generate different control signals, each of which is generated in accordance with a contact position of the object with the touch control unit; and

a transmission interface including a set of transmission lines interconnecting electrically the computing unit and the host unit, each of the transmission lines being used to transmit a respective one of the control signals to the host unit.

The operating system of the host unit is responsive to the control signal received from the transmission interface for scrolling control of the GUI display.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional graphical user interface (GUI) display with a scroll bar feature;

FIG. 2 is a schematic circuit block diagram of an electronic device that incorporates the preferred embodiment of a touch control module according to the present invention;

FIG. 3 is a schematic view to illustrate one example of a touch control unit for the touch control module of FIG. 2;

FIG. 4 is a schematic view to illustrate another example of a touch control unit for the touch control module of FIG. 2;

FIG. 5 illustrates how operation of the touch control unit of FIG. 3 can result in scrolling of a GUI display of the electronic device;

FIGS. 6(a) and 6(b) are sample control signals provided by the touch control module to an operating system in the electronic device of FIG. 2;

FIG. 7 is a schematic view to illustrate still another example of a touch control unit for the touch control module of FIG. 2; and

FIG. 8 is a schematic view to illustrate yet another example of a touch control unit for the touch control module of FIG. 2.

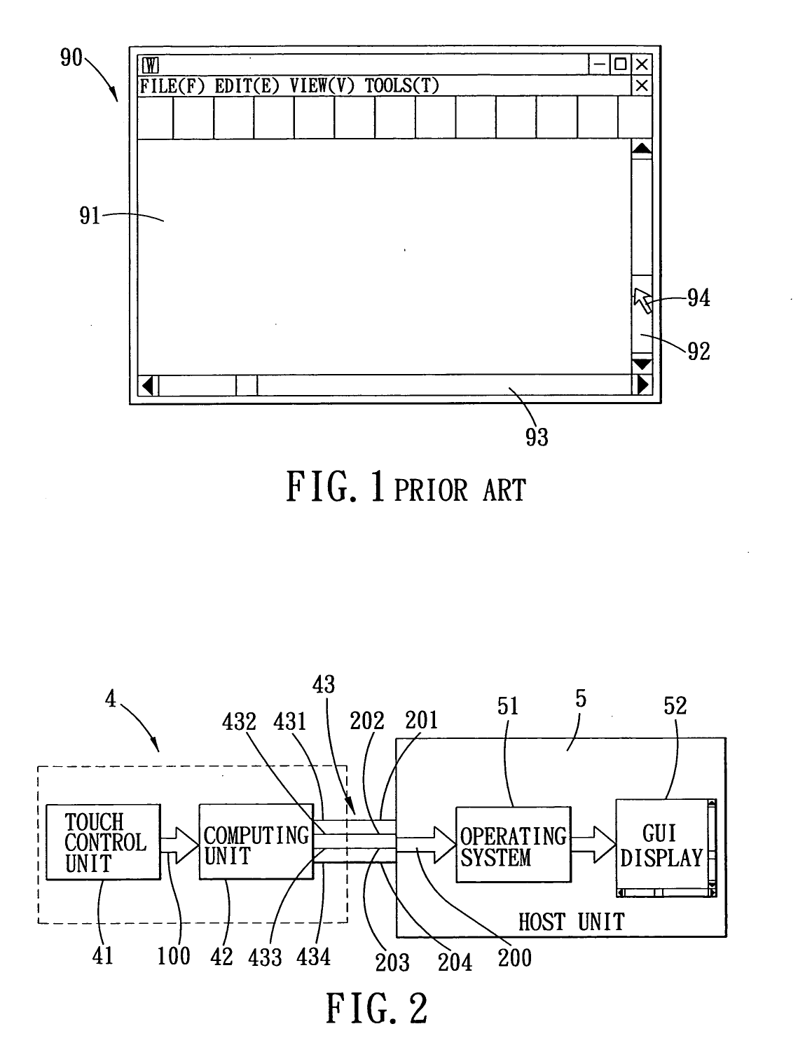

### DETAILED DESCRIPTION OF THE PREFERRED EMBODIMENT

Before the present invention is described in greater detail, it should be noted that like elements are denoted by the same reference numerals throughout the disclosure.

Referring to FIG. 2, the preferred embodiment of a touch control module 4 according to the present invention is used in conjunction with a host unit 5 of an electronic device. The host unit 5 includes an operating system 51 and a graphical user interface (GUI) display 52 having a scroll bar feature and operably associated with the operating system 5 in a conventional manner.

The touch control module 4 includes a touch control unit 41, a computing unit 42 coupled electrically to the touch control unit 41, and a transmission interface 43. In this embodiment, the transmission interface 43 includes first, second, third and fourth transmission lines 431, 432, 433, 434, each of which has a first end connected electrically to the computing unit 42, and a second end connected electrically to the host unit 5. Each of the first, second, third and fourth transmission lines 431, 432, 433, 434 is used to transmit a corresponding control signal from the computing unit 42 for reception by the host unit 5.

In use, when an object (not shown) contacts the touch control unit 41, a contact signal 100 is generated by the touch control unit 41 and is provided to the computing unit 42. Based on contact position of the object with the touch control unit 41, the computing unit 42 generates a corresponding control signal 200. In this embodiment, the different control signals 200 generated by the computing unit 42 include a first control signal 201, a second control signal 202, a third control signal 203, and a fourth control signal 204, which are transmitted to the host unit 5 via a respective one of the first, second, third and fourth transmission lines 431, 432, 433, 434 of the transmission interface 43.

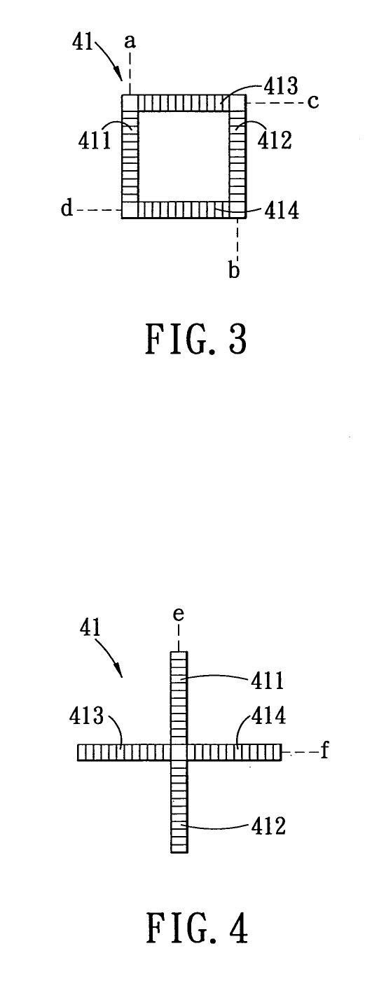

FIG. 3 illustrates one example of the touch control unit 41 for the touch control module 4. In the example of FIG. 3, the touch control unit 41, which is in the form of any known resistive, capacitive or light-sensitive touch control device, is defined with a first contact region 411, a second contact region 412, a third contact region 413, and a fourth contact region 414. The first and second contact regions 411, 412 are in the form of strips that extend along parallel first and second axes (a, b), respectively. The third and fourth contact regions 413, 414 are in the form of strips that extend respectively along parallel third and fourth axes (c, d) transverse to the first and second axes (a, b) . In the touch control unit 41 of FIG. 3, the first, second, third and fourth contact regions 411, 412, 413, 414 cooperate to form a closed rectangular loop.

FIG. 4 illustrates another example of the touch control unit 41 for the touch control module 4. In the example of FIG. 4, the touch control unit 41, which is in the form of any known resistive, capacitive or light-sensitive touch control device, is similarly defined with a first contact region 411, a second contact region 412, a third contact region 413, and a fourth contact region 414. The first and second contact regions 411, 412 are interconnected at one end and extend along a first axis (e). The third and fourth contact regions 413, 414 are interconnected at one end and extend along a second axis (f) transverse to the first axis (e). In the touch control unit 41 of FIG. 4, the third and fourth contact regions 413, 414 are connected to the interconnected ends of the first and second contact regions 411, 412 such that the first, second, third and fourth contact regions 411, 412, 413, 414 cooperate to form a cross-shaped configuration.

It should be noted herein that the object can be used to perform tap-and-drag, single-tap and double-tap operations on the touch control unit 41. Moreover, the specific arrangement of the first, second, third and fourth contact regions 411, 412, 4113, 413, 414 of the touch control unit 41 may be altered to suit the intended application.

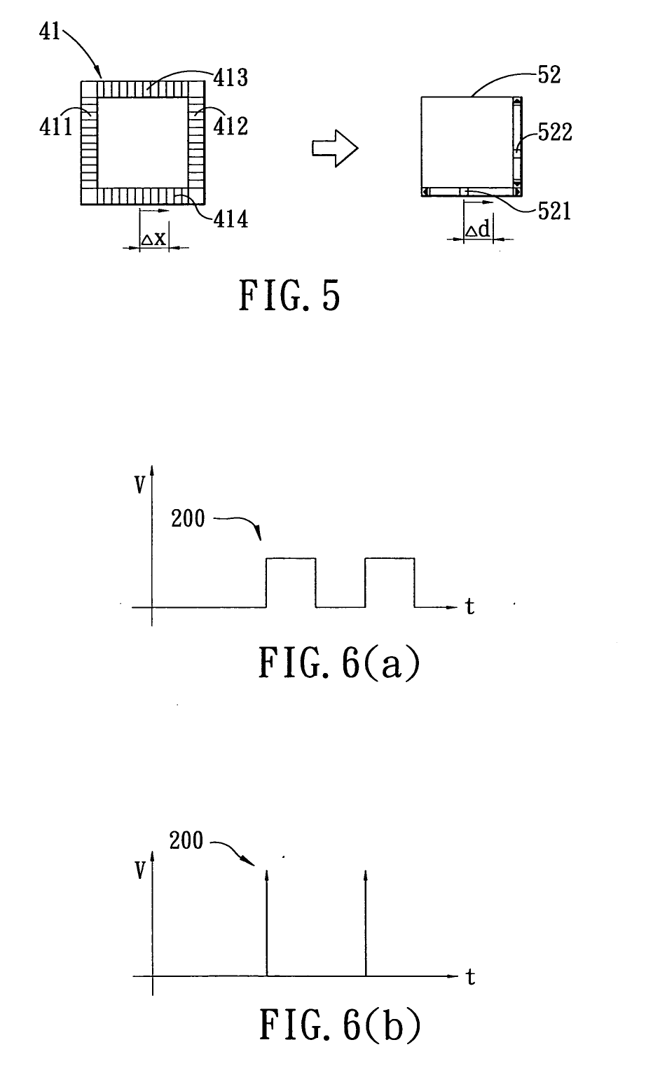

Referring to FIGS. 2, 3 and 5, each of the first, second, third and fourth contact regions 411, 412, 413, 414 is formed with parallel scan lines that are transverse to the axis (a, b, c, d) of the respective contact region 411, 412, 413, 414. Hence, movement of the object along each of the first, second, third and fourth contact regions 411, 412, 413, 414 can be sensed to result in generation of the corresponding contact signal 100.

Referring again to FIGS. 2 and 3, when a contact signal 100 due to contact of the object with the first contact region 411 is received by the computing unit 42, the computing unit 42 generates the first control signal 201 that is transmitted to the host unit 5 via the first transmission line 431. When a contact signal 100 due to contact of the object with the second contact region 412 is received by the computing unit 42, the computing unit 42 generates the second control signal 202 that is transmitted to the host unit 5 via the second transmission line 432. When a contact signal 100 due to contact of the object with the third contact region 413 is received by the computing unit 42, the computing unit 42 generates the third control signal 203 that is transmitted to the host unit 5 via the third transmission line 433. When a contact signal 100 due to contact of the object with the fourth contact region 414 is received by the computing unit 42, the computing unit 42 generates the fourth control signal 204 that is transmitted to the host unit 5 via the fourth transmission line 434. It should be noted therein that the control signal 200 generated by the computing unit 42 is preferably a pulse signal, such as the square wave pulse signal of FIG. 6(a) or the impulse signal of FIG. 6(b), that contains displacement information of the object on the touch control unit 41. Preferably, the control signal 200 contains a number of pulses that corresponds to the number of scan lines crossed by the object when the latter moves along the corresponding contact region 411, 412, 413, 414 of the touch control unit 41.

When the operating system 51 of the host unit 5 receives the control signal 200, an intended scrolling distance (such as in units of line, block or page) for the GUI display 52 of the host unit 5 is determined by the operating system 51 based on the displacement information contained in the control signal 200. In the preferred embodiment, the first control signal 201 corresponds to upward scrolling control for the GUI display 52, the second control signal 202 corresponds to downward scrolling control for the GUI display 52, the third control signal 203 corresponds to left-hand scrolling control for the GUI display 52, and the fourth control signal 204 corresponds to right-hand scrolling control for the GUI display 52. With reference to FIGS. 2, 3 and 5, when an object is used to perform a tap-and-drag operation on the fourth contact region 414, the computing unit 42 receives the corresponding contact signal 100 from the touch control unit 41, and generates the fourth control signal 204 that is transmitted to the host unit 5 via the fourth transmission line 434. In response to the fourth control signal 204, the operating system 51 calculates a moving distance (Δd) for a first scroll bar 521 of the GUI display 52 corresponding to the displacement (Δx) of the object on the fourth contact region 414 of the touch control unit 41.

A second scroll bar 522 of the GUI display 52 is controlled in a substantially similar manner. Particularly, when an object is used to perform a tap-and-drag operation on the first (or second) contact region 411 (412), the computing unit 42 receives the corresponding contact signal 100 from the touch control unit 41, and generates the first (or second) control signal 201 (202) that is transmitted to the host unit 5 via the first (or second) transmission line 431 (432). In response to the first (or second) control signal 201 (202), the operating system 51 calculates a moving distance for the second scroll bar 522 of the GUI display 52 corresponding to the displacement of the object on the first (or second) contact region 411 (412) of the touch control unit 41.

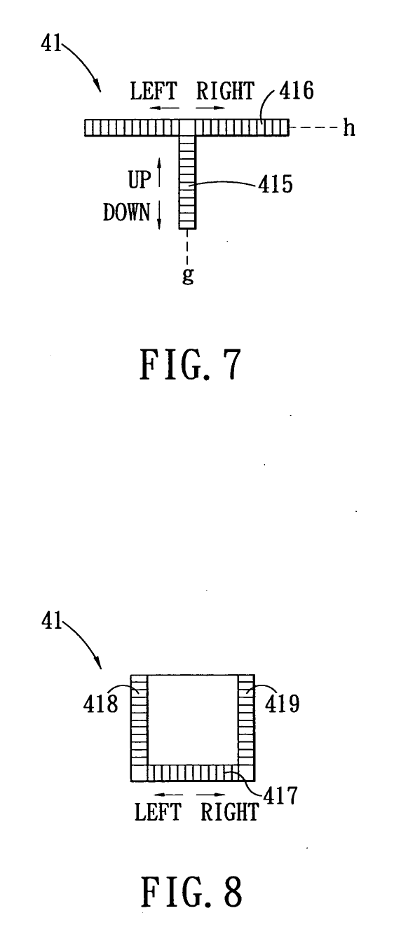

FIG. 7 illustrates still another example of the touch control unit 41 for the touch control module 4. In the example of FIG. 7, the touch control unit 41, which is in the form of any known resistive, capacitive or light-sensitive touch control device, is defined with a first contact region 415 and a second contact region 416. The first contact region 415 is in the form of a strip that extends along a first axis (g). The second contact region 416 is in the form of a strip that extends along a second axis (h) transverse to the first axis (g). One end of the first contact region 415 intersects an intermediate portion of the second contact region 416. The first contact region 415 is formed with parallel scan lines that are transverse to the first axis (g). On the other hand, the second contact region 416 is formed with parallel scan lines that are transverse to the second axis (h).

When a contact signal 100 due to movement of an object along the first contact region 415 in a first (upward) direction is received by the computing unit 42, the computing unit 42 generates the first control signal 201 that is transmitted to the host unit 5 via the first transmission line 431. When a contact signal 100 due to movement of the object along the first contact region 415 in a second (downward) direction is received by the computing unit 42, the computing unit 42 generates the second control signal 202 that is transmitted to the host unit 5 via the second transmission line 432. When a contact signal 100 due to movement of the object along the second contact region 416 in a third (left) direction is received by the computing unit 42, the computing unit 42 generates the third control signal 203 that is transmitted to the host unit 5 via the third transmission line 433. When a contact signal 100 due to movement of the object along the second contact region 416 in a fourth (right) direction is received by the computing unit 42, the computing unit 42 generates the fourth control signal 204 that is transmitted to the host unit 5 via the fourth transmission line 434.

FIG. 8 illustrates yet another example of the touch control unit 41 for the touch control module 4. In the example of FIG. 8, the touch control unit 41, which is in the form of any known resistive, capacitive or light-sensitive touch control device, is defined with first and second contact regions 418, 419 (similar to the first and second contact regions 411, 412 of FIG. 3), and a third contact region 417 (similar to the second contact region 416 of FIG. 7).The third contact region 417 extends transverse to the first and second contact regions 418, 419, and is connected to the first and second contact regions 418, 419 at opposite ends thereof. In the example of FIG. 8, the first, second and third contact regions 418, 419, 417 cooperate to form a U-shaped configuration.

In the touch control module 4 of this invention, the different control signals 201, 202, 203, 204 are transmitted to the host unit 5 via the different transmission lines 431, 432, 433, 434 of the transmission interface 43, respectively. In addition, because the control signals 201, 202, 203, 204 are in the form of pulse signals, the operating system 51 of the host unit 5 can easily decode the same so as to achieve the intended scrolling operation for the GUI display 52 without the need to perform complex packet transmission and decoding operations.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A touch control module comprising:
a touch control unit operable so as to generate a contact signal in response to contact with an object;
a computing unit coupled electrically to said touch control unit so as to receive the contact signal therefrom, said computing unit being configured to generate different control signals, each of which is generated in accordance with a contact position of the object with said touch control unit; and
a transmission interface including a set of transmission lines coupled electrically to said computing unit, each of said transmission lines being used to transmit a respective one of the control signals;
whereby, said transmission interface is adapted to provide the control signals to a host unit for scrolling control of a graphical user interface display of the host unit.

2. The touch control module as claimed in claim 1, wherein said touch control unit includes first and second contact regions, said computing unit generating a first one of the control signals in response to contact of the object with said first contact region, and a second one of the control signals in response to contact of the object with said second contact region.

3. The touch control module as claimed in claim 2, wherein said touch control unit further includes third and fourth contact regions, said computing unit generating a third one of the control signals in response to contact of the object with said third contact region, and a fourth one of the control signals in response to contact of the object with said fourth contact region.

4. The touch control module as claimed in claim 3, wherein said first, second, third and fourth contact regions are interconnected to form a closed loop.

5. The touch control module as claimed in claim 4, wherein said first, second, third and fourth contact regions are interconnected to form a rectangular loop.

6. The touch control module as claimed in claim 5, wherein:
said first and second contact regions are in the form of strips that extend along parallel first and second axes, respectively,
said third and fourth contact regions being in the form of strips that extend along parallel third and fourth axes, respectively,
said third and fourth axes being transverse to the first and second axes.

7. The touch control module as claimed in claim 6, wherein each of said first, second, third and fourth contact regions is formed with a plurality of parallel scan lines, each of which is transverse to the axis of the respective one of said contact regions.

8. The touch control module as claimed in claim 3, wherein said first and second contact regions are interconnected at one end, and said third and fourth contact regions are connected to said one end of said first and second contact regions.

9. The touch control module as claimed in claim 8, wherein said first and second contact regions are in the form of strips that extend along a first axis, and said third and fourth contact regions are in the form of strips that extend along a second axis transverse to the first axis.

10. The touch control module as claimed in claim 9, wherein each of said first, second, third and fourth contact regions is formed with a plurality of parallel scan lines, each of which is transverse to the axis of the respective one of said contact regions.

11. The touch control module as claimed in claim 1, wherein said touch control unit includes a first contact region, said computing unit generating a first one of the control signals in response to movement of the object along said first contact region in a first direction, and a second one of the control signals in response to movement of the object along said first contact region in a second direction opposite to the first direction.

12. The touch control module as claimed in claim 11, wherein said touch control unit further includes a second contact region, said computing unit generating a third one of the control signals in response to movement of the object along said second contact region in a third direction, and a fourth one of the control signals in response to movement of the object along said second contact region in a fourth direction opposite to the third direction.

13. The touch control module as claimed in claim 12, wherein said first contact region is connected at one end to said second contact region.

14. The touch control module as claimed in claim 13, wherein said first contact region is in the form of a strip that extends along a first axis, and said second contact region is in the form of a strip that extends along a second axis transverse to the first axis.

15. The touch control module as claimed in claim 14, wherein each of said first and second contact regions is formed with a plurality of parallel scan lines, each of which is transverse to the axis of the respective one of said contact regions.

16. The touch control module as claimed in claim 2, wherein said touch control unit further includes a third contact region, said computing unit generating a third one of the control signals in response to movement of the object along said third contact region in a first direction, and a fourth one of the control signals in response to movement of the object along said third contact region in a second direction opposite to the first direction.

17. The touch control module as claimed in claim 16, wherein said third contact region has opposite ends connected respectively to said first and second contact regions.

18. The touch control module as claimed in claim 17, wherein:
said first and second contact regions are in the form of strips that extend along parallel first and second axes, respectively,
said third contact region being in the form of a strip that extends along a third axis transverse to the first and second axes.

19. The touch control module as claimed in claim 18, wherein each of said first, second and third contact regions is formed with a plurality of parallel scan lines, each of which is transverse to the axis of the respective one of said contact regions.

20. The touch control module as claimed in claim 1, wherein each of the control signals is a pulse signal that contains at least one pulse.

21. The touch control module as claimed in claim 20, wherein each of the control signals contains displacement information of the object on said touch control unit.

22. The touch control module as claimed in claim 21, wherein each of the control signals contains a number of pulses indicative of the displacement information.

23. The touch control module as claimed in claim 20, wherein the pulse signal is a square wave signal.

24. An electronic device comprising:
a host unit including an operating system and a graphical user interface (GUI) display having a scroll bar feature and operably associated with said operating system;
a touch control unit operable so as to generate a contact signal in response to contact with an object;
a computing unit coupled electrically to said touch control unit so as to receive the contact signal therefrom, said computing unit being configured to generate different control signals, each of which is generated in accordance with a contact position of the object with said touch control unit; and
a transmission interface including a set of transmission lines interconnecting electrically said computing unit and said host unit, each of said transmission lines being used to transmit a respective one of the control signals to said host unit;
said operating system of said host unit being responsive to the control signal received from said transmission interface for scrolling control of said GUI display.

25. The electronic device as claimed in claim 24, wherein said touch control unit includes first and second contact regions, said computing unit generating a first one of the control signals in response to contact of the object with said first contact region, and a second one of the control signals in response to contact of the object with said second contact region.

26. The electronic device as claimed in claim 24, wherein said touch control unit includes a first contact region, said computing unit generating a first one of the control signals in response to movement of the object along said first contact region in a first direction, and a second one of the control signals in response to movement of the object along said first contact region in a second direction opposite to the first direction.

27. The electronic device as claimed in claim 24, wherein each of the control signals is a pulse signal that contains at least one pulse.

28. The electronic device as claimed in claim 27, wherein each of the control signals contains displacement information of the object on said touch control unit.

29. The electronic device as claimed in claim 28, wherein each of the control signals contains a number of pulses indicative of the displacement information.

30. The electronic device as claimed in claim 27, wherein the pulse signal is a square wave signal.
